(19) United States
(12) Patent Application Publication
(10) Pub. No.: US 2021/0106179 A1
(43) Pub. Date: Apr. 15, 2021

(54) STRAINER, INFUSER AND WHISK-ENCLOSED BOTTLE SYSTEM

(71) Applicant: Andrew Rogers, lee's summit, MO (US)

(72) Inventor: Andrew David Rogers, lee's summit, MO (US)

(21) Appl. No.: 16/600,438

(22) Filed: Oct. 11, 2019

(51) Int. Cl. A47J 43/27; B01F 15/00

(52) U.S. Cl. CPC A47J 43/27; B01F 11/008; B01F 15/00512

(57) ABSTRACT

A handheld mixing vessel, with removable lid, operatively containing a whisk and infuser enclosed system and a strainer to keep contents from flowing through the mouth opening at the top of the bottle. A hollow agitator positioned operatively near the top of the bottle and sits near the bottom of the bottle and thereby mixes fluid contained within the vessel, infuses fluid in the vessel and strains contents as they are poured out. An embodiment wherein a hand shaken motion will allow the whisk to mix and combine contents inside the structure. The enclosed feature of the mixing component allows for other uses such as but not limited to infusing tea, fruit, ice or other contents. The structure is also easy to clean and not mechanically complex. While also demonstrating the benefits of less noise created by no contact with the walls of the mixing structure and thus, avoiding the possibility of breakdown, scratching or other damage internally from contact.

### CROSS-REFERENCE TO RELATED APPLICATIONS

The present application claims priority to U.S. provisional patent application EFS #: 33981074 and application No. 62/744,259. The entire disclosure is included herein in its entirety at least by reference.

### BACKGROUND

### 1. Field of the Invention

The present invention relates generally to a beverage bottle system, and more specifically, to a beverage bottle system with a strainer and a whisk enclosed in the bottle.

### 2. Discussion of the State of the Art

In the art of water bottle design there are many different types that have been developed. They may be in plastic, glass or stainless steel and include a multitude of different attachments and components. These other bottles may have inefficient mixing capabilities that may damage or breakdown the internal components of the bottle. The bottle may not have a way to hold ice, or other contents from falling out of the mouth hole while consuming the liquid in the bottle. Some water bottles found today may have ability to infuse the liquid with tea, or fruit but the infuser is positioned to high in the bottle which causes inefficient infusing. A variety of approaches have been taken to provide for manual mixing of liquids or solids and liquids in a self-contained vessel. The most basic design utilizes a container with a removable lid that is shaken by and to effectuate the mixing of two more liquids or a dry substance and a liquid, such as depicted in the U.S. Pat. No. D510,235.

A drawback In U.S. Patent Application Publication No. 2004/0047231, a mixing structure, such as a wire ball, or conical object with through-holes is placed inside a bottle that is manually shaken to mix a powder with a liquid, such as infant formula with water. Drawbacks of this design include inadequate mixing because the mixing structure moves with the liquid, repeated impact of the mixing structure with the container walls, scratching and otherwise damaging the container and possibly causing material to break off the mixing structure or the container or both, as well as the noise generated by the contact.

An improvement is found in U.S. provisional patent application EFS #: 33981074 and application No. 62/744,259, wherein an enclosed mixing whisk is mounted near the top of the bottle, attached to the strainer. Thus, allowing for contents to be mixed manually with the shaking of the bottle. The enclosed feature of the mixing component allows for other uses such as but not limited to infusing tea, fruit, ice or other contents. The structure is also easy to clean and not mechanically complex. While also demonstrating the benefits of less noise created by no contact with the walls of the mixing structure and thus, avoiding the possibility of breakdown, scratching or other damage internally from contact.

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings. And so therefore, what is clearly needed is a water bottle and apparatus that solves the problems mentioned above; an embodiment that may allow infusing, an enclosed capsule where contents can be closed in and also but not limited to mixing contents with liquid effectively and efficiently.

### BRIEF SUMMARY

In accordance with the present disclosure, a container is provided that is designed to be shaken manually to cause the missing of elements within the container. The container is a hand held device for mixing that includes a mouth, a removable lid that may be attached to the housing, an opening at the top and enclosed at the bottom.

In an alternative embodiment, a device for mixing is provided that includes a housing having a closed end and an open end that may attach to a straining component within the structure. An embodiment wherein a hand shaken motion will allow the whisk to mix and combine contents inside the structure.

In accordance with one aspect of the present disclosure, a device for mixing is provided, the housing having a closed end and an open end. A straining component that may attach near the top of the bottle or lid; mounted horizontally. A straining embodiment with the ability to attach, detach and reattach a whisk or mixing element.

In accordance with another aspect of the disclosure, the whisk element is unique constructed of but not limited to a metal, plastic or other material to form a utensil that may be used for whipping, blending or mixing with a light rapid movement.

In accordance with a further aspect of the present disclosure, the whisk has a bulbous shape mounting vertically inside the vessel. The whisk will work in unison with the strainer and as mention can be detached and reattached. The open end will allow contents to be placed inside the whisk and then reattached to the strainer, using methods, but not limited to clipping, sliding, clasping, threading together.

### BRIEF SUMMARY OF THE SEVERAL VIEWS AND DRAWINGS

The foregoing and other features and advantages of the present disclosure will be more readily appreciated as the same become better understood from the following detailed description when taken in conjunction with the accompanying drawings, wherein:

FIG. 1. Is a front view of a strainer, infuser and whisk-enclosed beverage bottle system in accordance with a preferred embodiment of the present application.

FIG. 2. Is an expanded view of a strainer, infuser and whisk bottle lid.

FIG. 3. Is an isometric view of a strainer attached to an infuser and whisk enclosed system being used in the form of an infuser according to an embodiment of the present invention.

FIG. 4. Is a bottom plan view of an enclosed whisk system.

FIG. 5. Is a side plan view of an enclosed whisk system.

FIG. 6. Is a top plan view of a strainer that may connect to a lid in one embodiment.

FIG. 7. Is an expanded view of a strainer, infuser and whisk enclosed system.

FIG. 8. Is a top plan view of a strainer that may be disconnected from a lid in one embodiment.

### DETAILED DESCRIPTION OF THE PREFERRED EMBODIMENT

The inventor provides a unique system allowing a water bottle to complete three or more uses in one compendium, straining, infusing and mixing at a more robust level. The present invention is described in enabling detail in the following examples, which may represent more than one embodiment of the present invention.

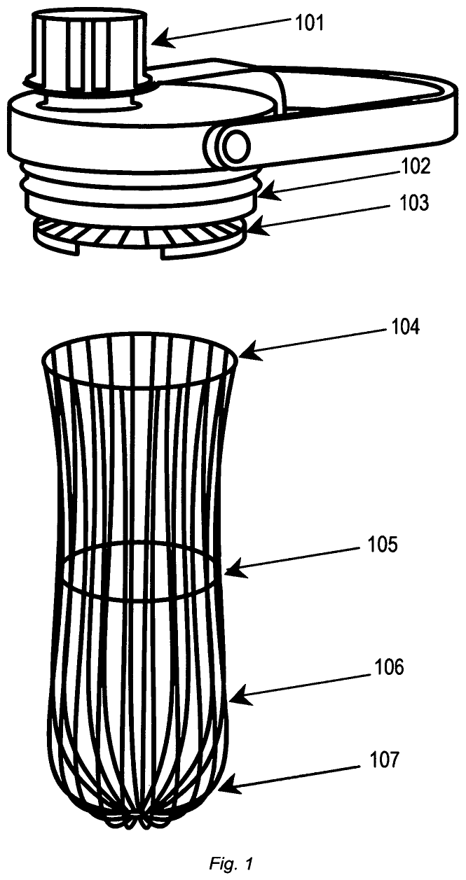

FIG. 1 is a front view of a strainer, infuser and whisk-enclosed beverage bottle system in accordance with a preferred embodiment of the present application. In this example bottle lid 101 has a strainer attached to the bottom of the lid 103.

It may be appreciated that in this example the strainer 103 is attached to the bottom of the lid 102. Although in another embodiment the strainer 103 may be detached. It may also be appreciated that strainer 103 will have an ability to have a whisk and strainer enclosed system 104 attached to it. This may happen through threading, sliding, clicking, but not limited to these methods of attachment.

In this example the infuser and whisk enclosed system 104 the top will attached to the strainer 103 connected to the bottom of the lid 102. This will allow the bottle to be shaken manually and as contents inside the bottle are moving around. The whisk structure 104 will be fixed in place to allow more robust mixing of the contents without noise and breakdown of the inside of the bottle.

Elements 105-107 in this example illustrate a plurality of whisk appendages running horizontally in the bottle. These whisk appendages 105-107 work to mix contents, such as a powder and a liquid placed inside the bottle. Appendages 105-107 may also be but no limited to, be running in a spiral or coil motion. As the bottle is shaken the contents in the bottle will move and as the contents move back into the strainer and whisk system 104, the force applied will cause all of the contents to be mixed and fused.

The whisk structure 101 in this example will have a spring element to it and molded from but not limited to a stainless steel, plastic or nylon filament, with some flexibility and pliability but characterized by the ability to bounce back to its original form.

It may also be appreciated in the embodiment of the present invention that items, such as but not limited to, ice, tea, fruit, etc. may be placed inside the infuser and whisk enclosed system 104. Then the system 104 may be attached to the strainer 103 allowing the contents placed inside to be enclosed in the structure 104.

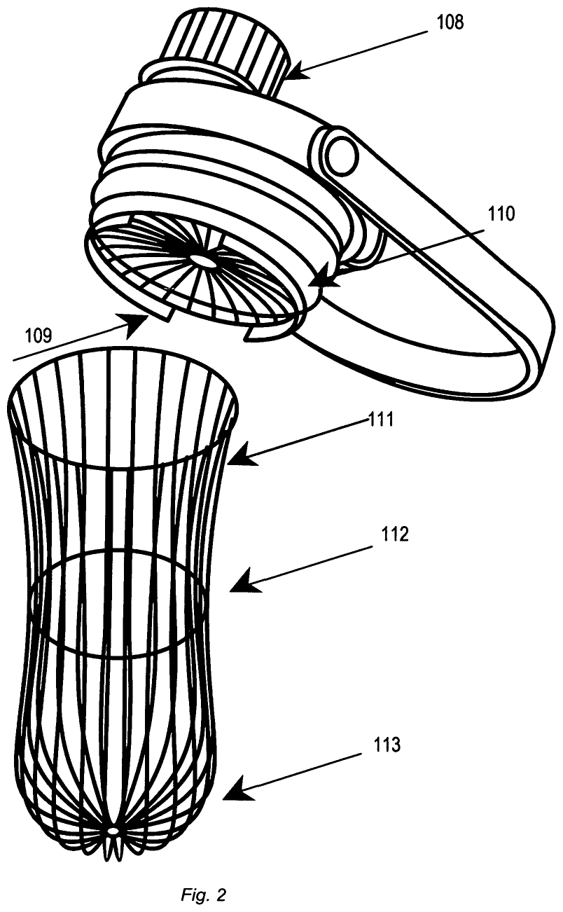

FIG. 2 is an expanded view of a strainer, infuser and whisk bottle lid in accordance with a preferred embodiment of the present application.

In this example the whisk system 101 with the elements 112-113 whisk appendages running vertically but may be constructed in other forms too, such as but not limited to spirals, coils or horizontal as mentioned previously. This example is also characterized by at least one strainer 109 and where in the improvement comprises whisk system 101 allowing infusing and mixing of contents.

The whisk system 111 is characterized by a larger opening at the top and tapered toward the middle then slightly larger toward the bottom. This is an ideal bulbous shape allowing the improvement room to add contents into opening on the top. Wherein, the bottom of 111 is enclosed holding those contents inside without allowing them to separate or move around in the bottle outside of the whisk 111; while its attached to the strainer 109.

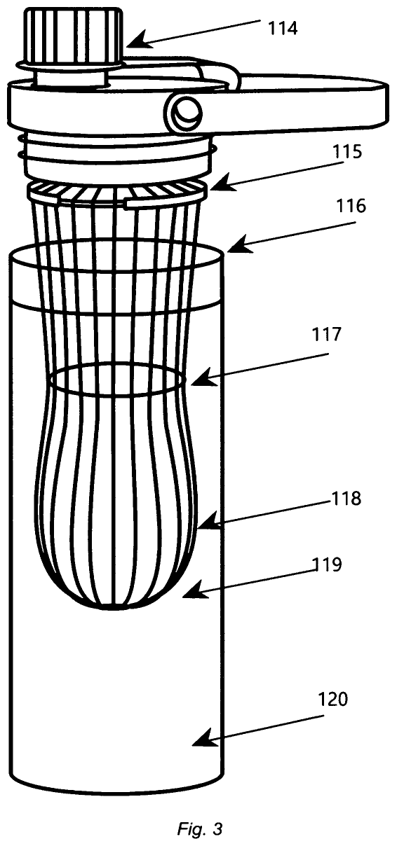

FIG. 3 is an isometric view of a strainer attached to an infuser and whisk enclosed system being used in the form of an infuser according to an embodiment of the present invention.

In this example the whisk system 116 has been connected to the strainer 115. This creates the enclosed environment that may house any contents placed into the system 116 prior to being attached. Whether the contents were tea, ice, fruit, or any other matter that one would like to have infused into the liquid without escaping the enclosure, which may be done so.

In addition in this example you are able to visualize when the liquid is consumed from the bottle. The strainer 115 will hold contents in place without letting them escape through the mouth hole 114.

It may also be appreciated in this example whisk system 116 has clearance around the inside of the bottle 120, which is ideal to prevent any destruction to the inside of the bottle.

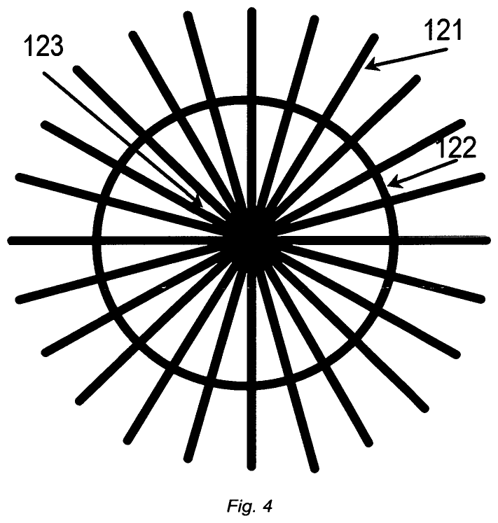

FIG. 4. Is a bottom plan view of an enclosed whisk system characterized by an enclosed end 123 and an open in at the top 121.

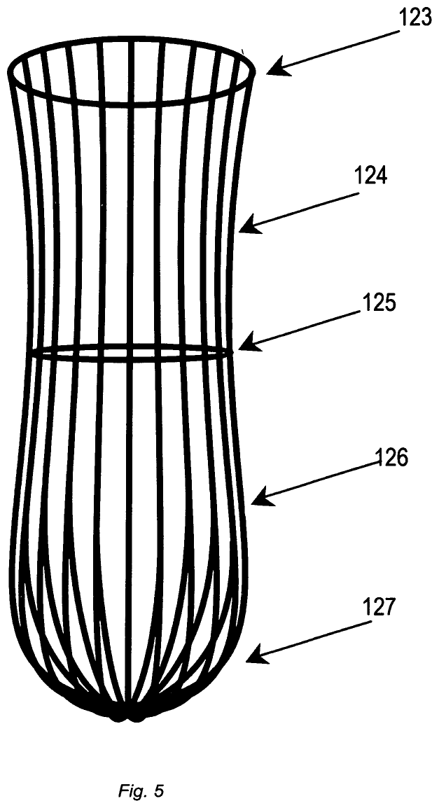

FIG. 5. Is a side plan view of an enclosed whisk system. In this example the whisk system is characterized by an opening at the top 123 to allow contents to be placed inside with an enclosed bottom 127. Additionally in this example the appendages are running vertically 124-126.

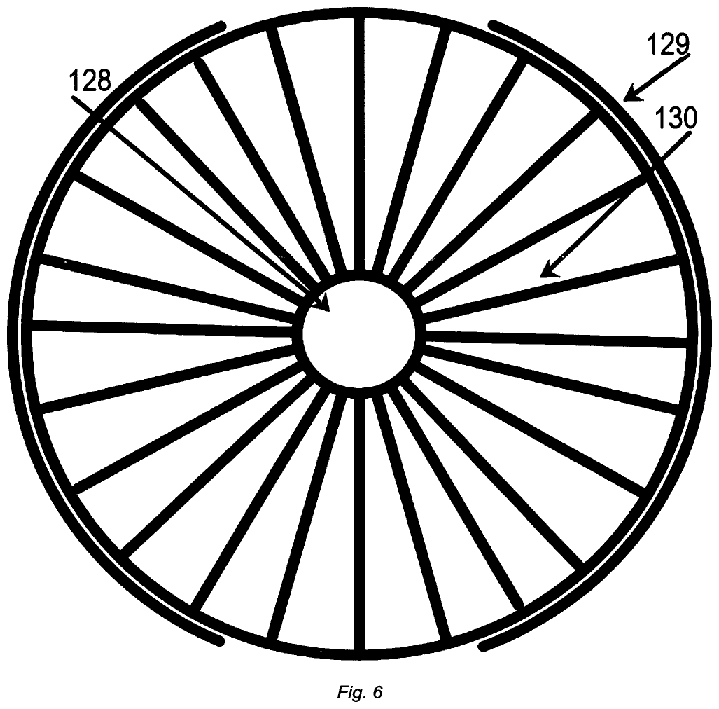

FIG. 6. Is a top plan view of a strainer that may connect to a lid in one embodiment characterized by a center point 128 that may be molded into the lid of the bottle.

In addition in this example appendages are fixed upon the side of the strainer 129 to hold the whisk in place when the two pieces are connected.

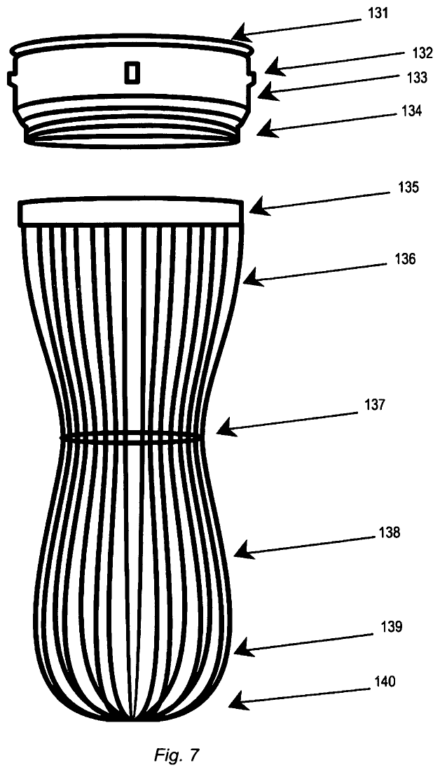

FIG. 7. Is an expanded view of a strainer, infuser and whisk enclosed system. In this example the whisk system 136 is illustrated with threads molded to the top 135. The threads 135 will connect to the bottom of a strainer 132. In this example the strainer 132 has threads at the bottom as well 134 to allow the two pieces 132 and 136 to attach firmly.

After being 132 and 136 are attached they may be placed inside the bottle. When the lid is screwed on the system is held in place and the bottle may be manually shaken to mix any contents inside the bottle.

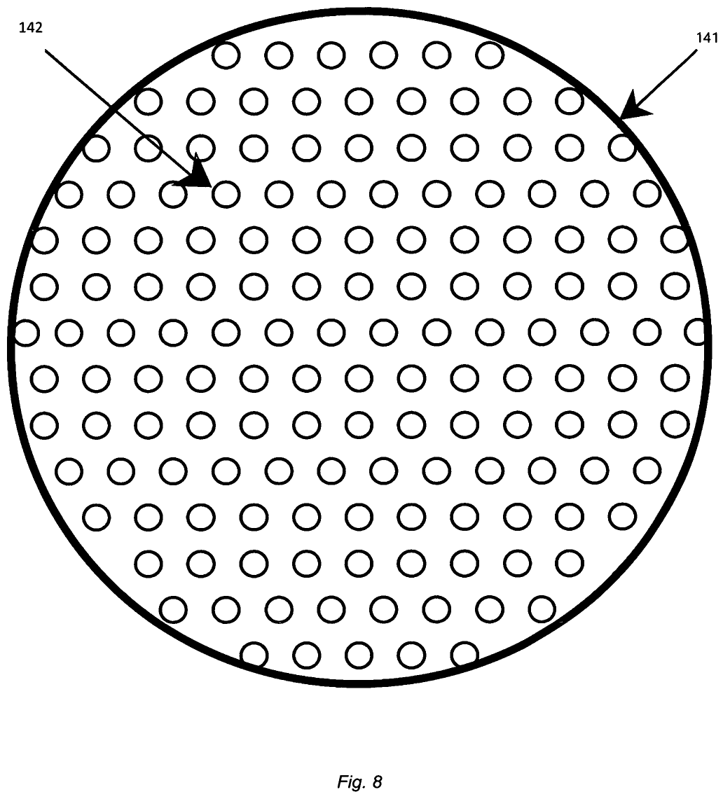

FIG. 8. Is a top plan view of a strainer 142 that may be disconnected from a lid in one embodiment. In this example the strainer will have connecters on the sides 141 which may be but not limited to threads, latches, or hinges.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

It will be apparent to one with skill in the art that the strainer, infuser and whisk-enclosed beverage system of the invention may be provided using some or all of the mentioned features and components without departing form the spirit and scope of the present invention. It will also be apparent to the skilled artisan that the embodiments described above are specific examples of a single broader invention which may have greater scope than any of the singular descriptions taught. There may be many alterations made in the descriptions without departing from the spirit and scope of the present inventions.

1. A handheld mixing bottle with fixed and removable agitator, comprising:
A mixing vessel, operatively containing a whisk and infuser enclosed system and a strainer to keep contents from flowing through the mouth opening at the top of the bottle; wherein
A bulbous shaped hollow agitator comprised of metal, nylon or other filament that positioned operatively near the top of the bottle and sits near the bottom of the bottle and thereby mixes fluid contained within the vessel, infuses fluid in the vessel and strains contents as they are poured out;
Wherein the whisk and infuser enclosed system has a main point of connection with the strainer to keep the agitator fixed in position to allow more thorough mixing of contents. As the liquid flows through the bottle when shaken the agitator stays fixed in place.

2. The whisk system of claim 1 wherein the internal attachment may connect to the strainer.

3. The whisk system of claim 2 where in the agitator can be connected to the strainer but also may disconnect for but not limited to cleaning or selective use.

4. The whisk system of claim 1 wherein the agitator frame has a spherical shape characterized by a springy framework with the ability to be connected or disconnected from the strainer.

5. The whisk system of claim 4 wherein the metal is made from one piece of material.

6. The whisk system of claim 4 wherein the agitator frame is a bulbous shape to allow contents to be inserted from the top to allow insertion of fruit, ice, tea, etc. but also enabling thorough mixing due to the whisk shape.

7. The strainer from claim 1 has a frame that may be attached to the lid or bottle with the purpose of straining the liquid as it moves from the bottle out of the mouth hole.

8. The strainer from claim 1 may also be able to be detached from the lid or the bottle but characterized by the ability to always be attachable to the whisk system to create the enclosed structure inside the bottle when needed.

9. The whisk system from claim 1 should be connected near the top of the bottle and stretch near the bottom of the bottle but will not have contact with the bottom or sides of the bottle.

10. The whisk system from claim 1 wherein the mixing element includes a plurality of appendages and concentric members spaced from each other.
